(19) United States
(12) Patent Application Publication
(10) Pub. No.: US 2008/0307468 A1
(43) Pub. Date: Dec. 11, 2008

(54) On-Demand Service System, On-Demand Data Collection System and Method for Providing On-Demand Service

(75) Inventor: Xiaojun Zeng, Shenzhen (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Tencent Technology (Shenzhen) Company Ltd., Guangdong Shenzhen (CN)

(21) Appl. No.: 12/189,481

(22) Filed: Aug. 11, 2008

Related U.S. Application Data
(63) Continuation of application No. PCT/CN2007/000502, filed on Feb. 13, 2007.

(30) Foreign Application Priority Data
Feb. 14, 2006 (CN) 200610007717.4

(51) Int. Cl. H04N 7/173

(52) U.S. Cl. 725/93; 725/87

(57) ABSTRACT

The present invention discloses an on-demand service system, including: a human-computer interaction center, a decision center, a program publishing system and a media file database; wherein the human-computer interaction center is adapted to collect on-demand service requests in a preset period of time; the decision center is adapted to identify the valid on-demand service requests among the on-demand service requests collected by the human-computer interaction center in the preset period of time; and the program publishing system is adapted to search for, in the media file database, the media files demanded by the valid on-demand service requests identified by the decision center. The present invention also discloses an on-demand data collection system and a method for providing on-demand service. The present invention enables democratic on-demand service pattern, i.e., a way of deciding the demanded program by a majority vote.

### FIELD OF THE INVENTION

The present invention relates to on-demand technologies, and particularly to an on-demand service system, an on-demand data collection system and a method for providing on-demand service.

### BACKGROUND OF THE INVENTION

More and more enterprises and TV stations provide on-demand services for customers via telephone hotlines or Internet at present. For example, a block diagram illustrating a conventional system for demanding TV programs via telephone calls is shown in FIG. 1. FIG. 1 shows that the conventional on-demand service system needs the assistance of telephone hotlines. A user dials a telephone service number and sends an on-demand service request according to voice instructions; the on-demand service request is passed through the telephone network and a gateway and is collected by an on-demand service request collection module; the collected on-demand service request is sent to a decision center, which is the core of the on-demand service system and is used for deciding whether the on-demand service request from the user is valid and what is the program demanded by the user; the decision center forwards the on-demand service request, which is confirmed to be valid, to a program publishing system and the program publishing system searches for and obtains the demanded program, according to the on-demand service request, from a media database that saves programs and transmits the obtained program to one or more TV sets through a passage for content (i.e., a channel) over the cable TV network so that the demanded program will be watched by all the audience whose TV sets receive the channel.

The inventor of the present invention found that, in such conventional on-demand service system, the on-demand service request regarded to be valid by the decision center is always from the first user that demands a program, the on-demand service requests from all other users will be ignored or suspended. Therefore, the on-demand service system answers only the on-demand service requests from a few users and the demands of the majority of the users who use the on-demand service are not satisfied.

### SUMMARY OF THE INVENTION

The present invention provides an on-demand service system, comprising: a human-computer interaction center, a decision center, a program publishing system and a media file database, wherein
the human-computer interaction center is adapted to collect on-demand service requests in a preset period of time and to output a media file from the program publishing system corresponding to valid on-demand service requests among the collected on-demand service requests;
the decision center is adapted to identify the valid on-demand service requests;
the program publishing system is adapted to search for, in the media file database, the media file demanded by the valid on-demand service requests identified by the decision center and export the media file to the human-computer interaction center.

The present invention further discloses an on-demand data collection system, comprising: a timer, adapted to keep time; and an on-demand data collection module, adapted to collect on-demand service requests during the period time set by the timer.

The present invention also discloses a method for providing on-demand service, comprising: collecting on-demand service requests during a preset period of time, identifying valid on-demand service requests among the collected on-demand service requests and broadcasting a program demanded by the valid on-demand service requests.

The on-demand service system and method provided by the present invention provide the following merits.

1. A democratic on-demand service pattern, i.e., a way of deciding the demanded program by a majority vote, is achieved by collecting on-demand service requests from users in a time period set by the timer, analyzing the on-demand service requests and broadcasting the program demanded by most of the on-demand service requests. Therefore the users' enthusiasm towards the on-demand service is promoted;

2. The broadcast program is always demanded by the on-demand service requests that are identified as valid according to a decision factor. The decision factor is configured and saved by a policy management module that provides decision factors for the decision center to identify currently valid on-demand service requests and the decision factor currently used can be adjusted according to requirements of the service.

### BRIEF DESCRIPTION OF THE DRAWINGS

FIG. 1 is a block diagram illustrating a system in the prior art that provides TV program on-demand service based on telephone calls;

FIG. 2 is a block diagram illustrating the on-demand service system in an embodiment of the present invention;

FIG. 3 is a block diagram illustrating the on-demand service system in another embodiment of the present invention;

FIG. 4 is a flow chart illustrating the method for providing on-demand service in an embodiment of the present invention.

### DETAILED DESCRIPTION OF THE INVENTION

In embodiments of the present invention, a timer is set up and on-demand service requests are collected during the time period set by the timer. The collected on-demand service requests are added into different categories, analyzed and identified according to preset decision factors and on-demand service requests among the collected on-demand service requests that satisfy the decision factors will be identified as valid on-demand service requests, then the program(s) demanded by the valid on-demand service requests will be broadcast. The decision factors may be the number of people that demand a program, the number of times that a program is demanded, or a specific program. When the decision factor is the number of people that demand a program, the valid on-demand service requests may be the requests that demand a program most of people demand; and when the decision factor is the number of times that a program is demanded, the valid on-demand service requests may be the requests that demand a program which is demanded by most on-demand service requests among the collected on-demand service requests.

The on-demand service system and method provided by the present invention are explained hereinafter with reference to telephone hotline based on-demand service and IPTV on-demand service respectively. The decision factor adopted in the following embodiments of the present invention is the number of people demanding a program.

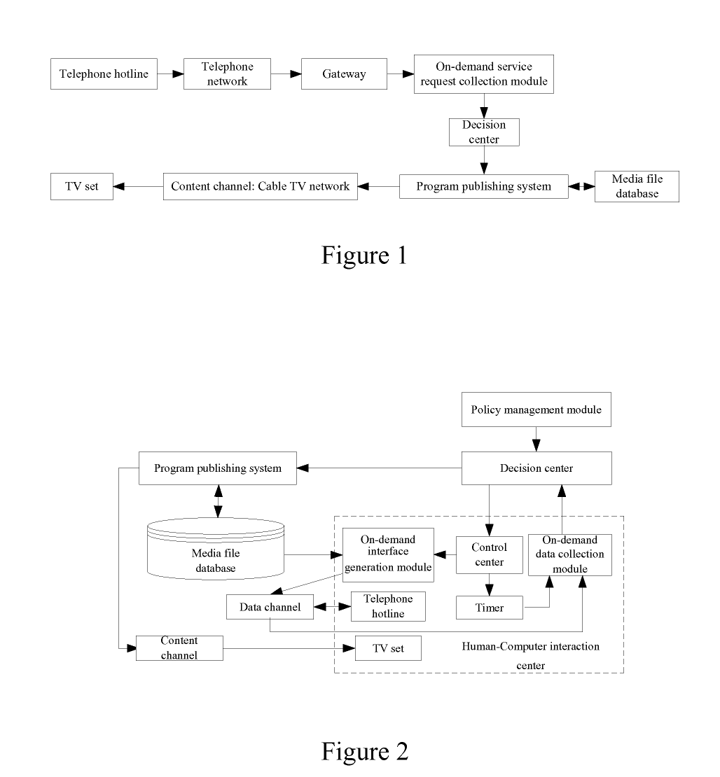

A block diagram illustrating the on-demand service system in an embodiment of the present invention is shown in FIG. 2.

In this embodiment, the on-demand service system in accordance with the present invention is described with reference to the telephone hotline based on-demand service. The on-demand service system provided in this embodiment includes a human-computer interaction center, a decision center, a program publishing system, a media file database, data channel(s) and content channel(s).

The human-computer interaction center is a platform on which a user interacts with the on-demand service system. The user may transmit an on-demand service request to the on-demand service system through the human- computer interaction center and the on-demand service system responds to the on-demand service request from the user. The human-computer interaction center includes a telephone hotline as the on-demand interface module, one or more TV sets as the on-demand program output modules, an on-demand data collection module, an on-demand interface generation module, a timer and a control center.

The telephone hotline is the interface through which the user demands a program and is regarded as an on-demand interface module. The telephone hotline responds to the operation of the user and transmits the on-demand service request from the user to the on-demand data collection module over a data channel such as the telephone network; the on-demand service request from the user includes the information on where the on-demand service request comes from, the time of the on-demand service request being transmitted and the serial number of the demanded media file.

The on-demand data collection module is controlled by the timer and adapted to collect on-demand service requests from all users during the time period set by the timer and forward the collected on-demand service requests to the decision center for further analysis and identification. The on-demand data collection module can work concurrently and continuously.

The timer is controlled by the control center and adapted to set and keep the time for an on-demand data (e.g., on-demand service requests) collection performed by the on-demand data collection module.

The control center is the core of the whole human-computer interaction center and is adapted to control the startup and the termination of the timer in order to determine the time of starting and ending the on-demand data collection by the on-demand data collection module, and is further adapted to control the on-demand interface generation module to generate an on-demand operation interface for users to use the on-demand service after the broadcasting of the demanded program, and is adapted to transmit the information of the valid on-demand service requests identified by the decision center to the on-demand interface generation module to inform the user of the valid on-demand service requests.

The on-demand interface generation module is adapted to obtain information and attributes of the programs available on demand from the media file database, generate the on-demand operation interface under the control of the control center and provide the on-demand operation interface for telephone hotline users over the data channel so that a clear and convenient on-demand operation interface may be provided for the users.

The one or more TV sets are adapted to show the user the information of the program demanded by the valid on-demand service requests, therefore the one or more TV sets can be regarded as an on-demand program output module and can be adapted to show an on-demand program menu for the users.

The decision center is adapted to receive the on-demand service requests collected by the on-demand data collection module, analyze the on-demand service requests based on the information carried in the on-demand service requests, find out the media file that is requested by most of the collected on-demand service requests, and submit the unique serial number of the media file to the program publishing system and the control center so that the program publishing system can find the media file in the media file database according to the serial number of the media file and the control center can notify the on-demand interface generation module of the media file demanded by the valid on-demand service requests and further inform the users of the valid on-demand service requests via the telephone hotline over the data channel.

The program publishing system is adapted to receive from the decision center the unique serial number of the media file requested by the valid on-demand service requests, find the media file from the media file database according to the unique serial number and publishing the media file over the content channel, e.g., the cable TV network, to the one or more TV sets which function as the on-demand program output modules. Now all the audience of the channel can watch the media file.

The media file database is adapted to save the media files which are available on demand and are used by the on-demand interface generation module; each of the media files saved in the media file database has a unique serial number. Furthermore, the media file database can be updated frequently and the on-demand interface generation module shall be informed of the update in time so that the on-demand interface generation module can modify the on-demand operation interface under the control of the control center as soon as possible.

The data channel is the channel between the user and the on-demand service system adapted for on-demand service interaction. In this embodiment, the data channel includes the telephone network and the gateway. However, in on-demand service systems on different networks, the data channel may include, but are not limited to, cable TV network, the Internet and the wireless network.

The content channel is the passage for the media file to reach the on-demand program output module (e.g., TV set) and in this embodiment the content channel includes the cable TV network. However, in on-demand service systems on different networks, the content channels may include, but are not limited to, cable TV network, the Internet and the wireless network. Furthermore, the content channel can be combined with the data channel into one single channel.

The on-demand service system may further include a policy management module adapted to configure and save different decision factors and provide the decision center with the decision factor needed for current on-demand service. In this way the system may adopt different decision factors based on different service requirements, e.g., the system may make the decision based on the number of people demanding a program, the number of times that a program is demanded, or the profit of a program.

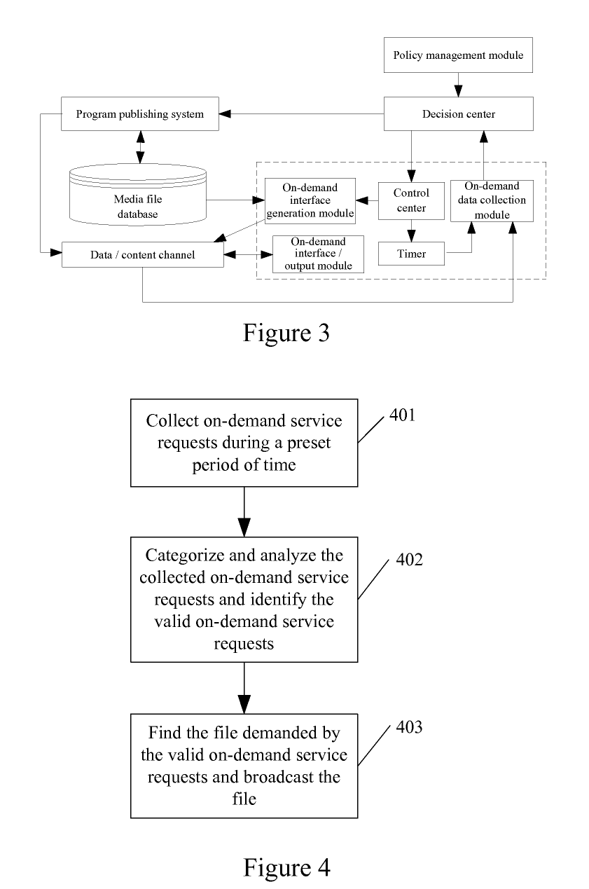

A block diagram illustrating the on-demand service system in another embodiment of the present invention is shown in FIG. 3.

In this embodiment, the on-demand service system in accordance with the present invention is described with reference to the Internet Protocol TV (IPTV) program on-demand service. Similar to the preceding embodiment, the on-demand service system in this embodiment also includes a human-computer interaction center, a decision center, a program publishing system and a media file database; the difference lies in that the data channel and the content channel in this embodiment are combined into one single channel, i.e., the data/content channel, which is adapted for both the on-demand service interaction between the user and the on-demand service system and the delivery of the demanded media file to the on-demand program output module. In this embodiment, the data/content channel may be the Internet.

The human-computer interaction center in this embodiment is similar to the human-computer interaction center in the preceding embodiment, however, the telephone hotline which functions as the on-demand interface module and the TV set which functions as the on-demand program output module in the preceding embodiment are replaced with a network TV in this embodiment as a combined on-demand interface/output module. When a user demands a program, the network TV functions as the on-demand operation interface that shows the on-demand program menu for the user to operation on; when the program corresponding to the valid on-demand service requests are broadcast, the network TV functions as the program playback interface that shows the program corresponding to the valid on-demand service requests.

The on-demand service system may further include a policy management module adapted to configure and save different decision factors and provide the decision center with the decision factor needed for current on-demand service. In this way the system may adopt different decision factors based on different service requirements, e.g., the system may make the decision based on the number of people demanding a program, the number of times that a program is demanded, or the profit of a program.

An embodiment of the present invention also provides an method for providing on-demand service, as shown in FIG. 4. FIG. 4 is a flow chart illustrating the method for providing on-demand service in an embodiment of the present invention, including the following steps:

Step 401: collecting on-demand service requests during a preset period of time.

Every on-demand service request includes the information indicating the origination of the on-demand service request, the serial number of the file requested by the on-demand service request and the time when the on-demand service request is sent.

Step 402: analyzing the on-demand service requests collected and identifying the valid on-demand service requests.

The valid on-demand service requests are identified according to a preset decision factor. Just like in the preceding embodiment, the current decision factor adopted can be chosen from the policy management module and on-demand service requests that meet the decision factor will be identified as the valid on-demand service requests. The decision factor may be: a program that is demanded by most on-demand service requests, or a program that produces highest profit when being demanded. This embodiment should not be regarded as a limit to the decision factor.

In this embodiment, the on-demand service requests are categorized based on the information in the requests on the serial numbers of the demanded files, i.e., the on-demand service requests carrying the same file serial number will be put into the same category and the numbers of requests in different categories respectively are compared with one another so that a category covering more on-demand service requests than any other category does can be found and the file corresponding to the on-demand service requests in the category will be identified as the file demanded by the valid on-demand service requests. That is, the file demanded by most on-demand service requests will be identified as the file demanded by the valid on-demand service requests.

With respect to a different service requirement, the on-demand service requests can also be categorized based on the information in the requests on the serial numbers of the demanded files and the profit of a category of on-demand service requests equals the profit of the file corresponding to the category multiplied by the number of the on-demand service requests in the category; the profits of different categories are compared with one another and the file corresponding to the category with the highest profit will be identified as the file demanded by the valid on-demand service requests. That is, the file that produces highest profit in the on-demand service will be identified as the file demanded by the valid on-demand service requests. For example, provided the on-demand service requests are divided into two categories, Category A covers 30 on-demand service requests and Category B covers 25 on-demand service requests; the profit of the file corresponding to requests in Category A is CNY 3 per view and the profit of the file corresponding to requests in Category B is CNY 4 per view; the final decision will be that the file corresponding to requests in Category B is the file demanded by valid on-demand service requests.

Step 403: finding the file demanded by valid on-demand service requests and broadcasting the file.

The file demanded by valid on-demand service requests is searched for in the media file database according to the serial number of the file and the found file is broadcast. Therefore the on-demand service is completed.

It can be seen from the preceding description that the embodiments of the present invention set up a timer in the on-demand service systems and the on-demand service requests collected during the period of time set by the timer are analyzed, compared and identified to find the file that is demanded by more on-demand service requests than any other files are. In this way the democratic on-demand service pattern, i.e., the way of deciding the demanded program by a majority vote, is achieved.

The preceding description explains the composition of the on-demand service system in embodiments of the present invention and the following description will explain the on-demand service flow, based on telephone hotline or IPTV respectively, of the on-demand service system with reference to a method for providing on-demand service mentioned in the embodiments of the present invention.

1. Telephone hotline based on-demand service flow.

The on-demand interface generation module generates, under the control of the control center, an on-demand operation interface for users based on the program information saved in the media file database and sends the interface to the telephone hotline over the data channel. The control center controls the timer to trigger the on-demand data collection module to collect the on-demand service requests sent by the users over the data channel via the telephone hotline during the period of time set by the timer, each of the on-demand service requests carries information such as the serial number of the demanded media files. The on-demand data collection module forwards the collected on-demand service requests to the decision center, which analyzes all the on-demand service requests and identifies the requests that meet the present decision factor as valid on-demand service requests; the decision center further sends the serial number of the media file demanded by the valid on-demand service requests to the program publishing system and the control center. The control center informs the on-demand interface generation module of the information on the valid on-demand service requests and the on-demand interface generation module in turn informs users of such information over the data channel and the telephone hotline; after the broadcast of the demanded media file, the control center may further control the on-demand interface generation module to generate the on-demand operation interface and control the timer to trigger the on-demand data collection module to collect on-demand service requests again, i.e., a new round of on-demand service will start. The program publishing system finds the media file demanded by the valid on-demand service requests in the media file database according to the media file serial number carried by the valid on-demand service requests, broadcasts the media file to one or more TV sets. The one or more TV sets play the media file demanded by the valid on-demand service requests and the democratic on-demand service pattern, i.e., the way of deciding the demanded program by a majority vote, is achieved.

2. IPTV based on-demand service flow.

In this service flow, the composition and functions of the on-demand service system are the same as those of the on-demand service system in the telephone hotline based on-demand service flow. The on-demand interface generation module generates, under the control of the control center, an on-demand operation interface for users based on the program information saved in the media file database and sends the interface to the on-demand interface/output module over the data/content channel. The control center controls the timer to trigger the on-demand data collection module to collect the on-demand service requests sent by the users over the data/content channel via the on-demand interface/output module during the period of time set by the timer, each of the on-demand service request carries information such as the serial number of the demanded media files. The on-demand data collection module forwards the collected on-demand service requests to the decision center, which analyzes the on-demand service requests and identifies the requests that meet the present decision factor as valid on-demand service requests; the decision center further sends the serial number of the media file demanded by the valid on-demand service requests to the program publishing system and the control center. The control center informs the on-demand interface generation module of the information on the valid on-demand service requests and the on-demand interface generation module in turn informs users of such information via the data/content channel ; after the broadcast of the demanded media file, the control center may further control the on-demand interface generation module to generate the on-demand operation interface and control the timer to trigger the on-demand data collection module to collect the on-demand service requests again, i.e., a new round of on-demand service will start. The program publishing system finds the media file demanded by the valid on-demand service requests in the media file database according to the media file serial number carried by the valid on-demand service requests, sends the media file to the on-demand interface/output module over the data/content channel. The on-demand interface/output module broadcasts the media file demanded by the valid on-demand service requests and the democratic on-demand service pattern, i.e., the way of deciding the demanded program by a majority vote, is achieved.

The on-demand service system provided by the present invention is described in the preceding two embodiments which are based on telephone hotline and IPTV respectively. Accordingly, the embodiments of present invention also provide an on-demand data collection system as a part of the on-demand service system. The on-demand data collection system includes: an on-demand data collection module and a timer, wherein the on-demand data collection module is adapted to collect on-demand service requests and output the on-demand service requests collected during a period of time set by the timer when the period of time is up. The system may further includes an on-demand interface generation module, adapted to provide an on-demand operation interface showing the media file information for users of the on-demand service. In practical applications, the system may further include a control center that controls the components in the system in a centralized way. The control center is adapted to control the on-demand interface generation module to collect media file information from the media file database and generate the on-demand operation interface and is adapted to control the timing process of the timer; the on-demand data collection module is then adapted to start collecting the on-demand service requests when the timer starts timing and output the on-demand service requests collected during the period of time set by the timer. The functions and working theories of the components in the on-demand data collection system have already been described in preceding description and will not be described further hereinafter.

The foregoing description describes the on-demand service system and method provided by the present invention with reference to telephone hotline and IPTV based embodiments only, however, the system and method provided by the present invention can also be applied to other types of similar on-demand services.

The foregoing description is only preferred embodiments of the present invention and is not for use in limiting the protection scope thereof.

1. An on-demand service system, comprising: a human-computer interaction center, a decision center, a program publishing system and a media file database, wherein
the human-computer interaction center is adapted to collect on-demand service requests in a preset period of time and to output a media file from the program publishing system corresponding to valid on-demand service requests among the collected on-demand service requests;
the decision center is adapted to identify the valid on-demand service requests;
the program publishing system is adapted to search for, in the media file database, the media file demanded by the valid on-demand service requests identified by the decision center and export the media file to the human-computer interaction center.

2. The system according to claim 1, further comprising: a policy management module, adapted to provide at least one decision factor for the decision center; wherein
the decision center identifies the valid on-demand service requests according to the at least one decision factor provided by the policy management module.

3. The system according to claim 1, wherein the media file database is adapted to save media files and the human-computer interaction center is further adapted to generate an on-demand operation interface based on media files currently saved in the media file database and the on-demand operation interface is adapted to provide users with information on the media files available on demand.

4. The system according to claim 3, wherein the human-computer interaction center further comprises:
a control center, adapted to control a timer and an on-demand interface generation module;
the on-demand interface generation module, adapted to generate, under the control of the control center, an on-demand operation interface based on the media files currently saved in the media file database;
an on-demand interface module, adapted to obtain the on-demand operation interface over a data channel from the on-demand interface generation module, provide the on-demand operation interface for users and output the on-demand service requests from the users over the data channel;
the timer, adapted for timekeeping under the control of the control center;
an on-demand data collection module, adapted to collect the on-demand service requests from the on-demand interface module over the data channel during a period of time set by the timer; and
an on-demand program output module, adapted to receive, from the program publishing system over a content channel, the media file demanded by the valid on-demand service requests and broadcast the media file.

5. The system according to claim 4, wherein the on-demand interface module and the on-demand program output module are combined into one module, the data channel and the content channel are combined into one channel.

6. An on-demand data collection system, comprising:
a timer, adapted for timekeeping; and
an on-demand data collection module, adapted to collect on-demand service requests during a period of time set by the timer.

7. The system according to claim 6, further comprising:
an on-demand interface generation module, adapted to generate an on-demand operation interface which provides users with information on the media files available on demand.

8. The system according to claim 7, further comprising:
a control center, adapted to control the on-demand interface generation module to collect media file information and generate the on-demand operation interface, and adapted to control the timekeeping of the timer; wherein
the on-demand data collection module is further adapted to start collecting on-demand service requests when the timer starts and to output the on-demand service requests collected during the period of time set by the timer.

9. A method for providing on-demand service, comprising:
collecting on-demand service requests during a preset period of time; and
identifying valid on-demand service requests among the collected on-demand service requests and broadcasting a media file demanded by the valid on-demand service requests.

10. The method according to claim 9, further comprising: generating an on-demand operation interface based on information of currently saved media files, wherein the on-demand operation interface is adapted to provide users with information of the media files available on demand and enable users to send on-demand service requests according to the on-demand operation interface.

11. The method according to claim 9, further comprising: saving at least one decision factor used for identify the valid on-demand service requests; wherein
identifying the valid on-demand service requests among the collected on-demand service requests further comprises:
selecting one decision factor from the at least one decision factor saved;
identifying on-demand service requests among the collected on-demand service requests that meet the selected decision factor as the valid on-demand service requests.

12. The method according to claim 11, wherein the at least one decision factor saved comprises: a media file that is demanded by most on-demand service requests; and/or, a media file that profits most; and/or, a media file that is demanded by most people.
